(19) United States
(12) Patent Application Publication
(10) Pub. No.: US 2004/0052999 A1
(43) Pub. Date: Mar. 18, 2004

(54) Interlaced panels for support surfaces

(76) Inventor: D. Scott Rogers, Lafayette, LA (US)

Correspondence Address: Len R. Brignac, Suite 3800, 201 St. Charles Avenue, New Orleans, LA, 70170, US

(21) Appl. No.: 10/652,367

(22) Filed: Aug. 29, 2003

Related U.S. Application Data
(60) Provisional application No. 60/410,368, filed on Sep. 13, 2002.

(51) Int. Cl. B32B 3/10

(52) U.S. Cl. 428/44; 428/52

(57) ABSTRACT

A lightweight, interlaced panel system for use in temporary walkways, worksites, airfields, roadways, tent floors and other support surfaces comprising a plurality of partially overlapping and inter-connectable individual panels, wherein each panel is made from rigid, polymeric, plastic materials, and wherein each panel has a lip section on two sides of the panel that is integrated in the panel's body; wherein the panel with the lip is formed during a molding process and does not rely on any further assembly. The panels have uniformly spaced holes for receipt of binding cord and the panels are interlaced together by the binding cord with each panel having adjoining perimeter lips which overlap with an adjacent panel's perimeter lips and to form an easily assembled and interconnected flat surface.

### CROSS REFERENCE

The present application is based on Provisional Application, Serial No. 60/410,368, filed Sep. 13, 2002.

### BACKGROUND

1. Field of the Invention

The present invention relates to a portable structural ground support to be used for a variety of uses. With multiple, rigid overlapping panels interlaced together with cord, the interlaced panels provide portable, temporary, structural ground support for a variety of uses, including temporary building floors, support for outdoor worksites, walkways, wheelchair access and helicopter landing pad and other uses.

2. Description of Related Art

Temporary support surfaces in a variety of embodiments have long been used, and mat systems and interconnected panel systems are known. A few examples of U.S. patents that disclose mat systems used as support surfaces are as follows:

U.S. Pat. No. 6,214,428B1 (A laminated wooden support mat fitted with one or more wear mat or pad and are bolted together);

U.S. Pat. No. 4,289,420 (A wooden mat to form a roadway from interlocking mats, each mat being formed from a plurality of layers or boards, each layer being formed from boards parallel to each other and perpendicular to boards forming the adjacent layer.);

U.S. Pat. No. 4,875,800 (A temporary support structure with a plurality of panels is disclosed. Each panel includes a first row of boards arranged in a parallel side-by-side relationship, and a second row of boards arranged in a parallel side-by-side relationship. The second row of boards is superimposed on the first row of boards and oriented perpendicularly thereto. A first plurality of panels defines a lower layer in which the second row of boards extends upwardly to define lower locking boards. A second plurality of panels defines an upper layer resting upon the lower layer wherein the second row of boards thereof extends downwardly to define upper locking boards intermeshed with the lower locking boards. Individual panels of the upper layer are intermeshed with a plurality of lower panels to create an interlocking relationship therewith.);

U.S. Pat. No. 4,973,193 (Matting system is disclosed that includes interlocking mats of four differing configurations. Each mat configuration consists of wooden boards fastened together to create from one to three layers of boards at various areas of the individual mats.);

U.S. Pat. No. 4,462,712 (A flooring system for use at a construction site, such as an oil well drilling site, is disclosed. The flooring system is formed by interlocking a plurality of flooring units. Each of the flooring units includes a rectangular base section and a surface section attached to and overlaying the base section. One end of the rectangular base section is aligned with one end of the surface section which has at least one open-ended locking slot along its length. Located on the opposing end of the surface section is at least one locking tab formed from the surface section and projecting beyond and above the edge of the base section. The locking tab is aligned with the locking slot of the flooring unit.);

U.S. Pat. No. 5,653,551 (A reusable mat for constructing roadways and equipment support surfaces comprising a plurality of uniform individual mats constructed of light weight composite materials is disclosed. The individual mats partially overlap and interlock to form a continuous and substantially smooth surface.);

U.S. Pat. No. 6,511,257 (A reusable mat for construction of load bearing surfaces is disclosed. The individual mats interlock on all sides to form a stable and continuous loadbearing surface.);

U.S. Pat. No. 4,629,358 (Low profile portable panels that have recessed molded lips and bushing along edges for connecting panels together with bolts to form expedient airfield is disclosed.);

U.S. Pat. No. 6,214,428B ( A laminated support mat constructed of wood and cable loops.);

U.S. Pat. No. 4,604,962 (An interlocking assembly for modular loading dock units is disclosed.);

U.S. Pat. No. 5,820,294 (Mats as pathways for wheelchair access on unstable soil is disclosed.)

### SUMMARY

Industrial work and military operations frequently are undertaken in remote areas and/or areas with unstable and/or unsuitable surfaces. The present invention is portable, durable, reusable, lightweight, easily repairable, has low cost construction, and is easily deployed. Any successful, interlocking mat system used for support surfaces must provide substantial holding strength to prevent lateral and vertical separation of the mats. Existing devices to secure such mats include fasteners with carriage bolts or other locking elements.

The invention utilizes panels attached together by a binding cord, that is passed through aligned openings in the overlapping panels, to form temporary support structure for a variety of uses. The panels used in the interlaced panel system are preferably made from rigid, polymeric, plastic materials, rubber or any other material that results in lightweight rigid or semi rigid panels. In addition, the panel includes a recessed lower lip section on two sides of the panel that is integrated in the panel's body. The recessed lower lip fits underneath an adjacent panel and allows for overlapping panels to have a uniformly flat upper surface. The panel with the lip is formed during manufacturing by a molding process and does not rely on any further assembly. The recessed lip allows for panels to be overlapped providing for a uniformly flat upper surface.

The panels have uniformly spaced holes that align when the panels overlap for receipt of a cord to stitch or interlace overlapping adjacent panels together in a quilt-like manner. The panel system is assembled by passing a flexible binding cord, such as rope or wire, through multiple aligned holes in the upper and lower panel edges of overlapping panels. A cord or cords stitched through aligned holes of multiple adjacent panels allow the panel system to be constructed into the desired shape and surface area. The preferred binding cord is durable, flexible and sized at approximately ⅛ inch diameter with a polyester braid; however the cord size should be larger for large size panels.

The panel system can be preassembled, and the panel system does not have to assembled and completely disassembled at each new work location. The use of a flexible cord as a binding means provides flexibility and deflection in interlaced panels. The flexibility allows the assembled panels to be rolled up for storage and transport and the interlaced panels will return to a flat surface upon deployment. This flexibility feature allows for transport and deployment of an already assembled support structure. The size of the panels must be small enough for such a multipanel system to have sufficient flexibility.

The flexibility in the panel can, for example, allow for helicopter transport and deployment as a landing pad on sandy, rocky or muddy terrain. Likewise, the similar transport and deployment can be utilized from vehicles.

Many known mats have various attachment means. However, the interlaced flexible cord allows for movement and bending of adjacent panel, and each panel is flexible allowing for temporary deformity when under load or when rolled for transport and/or storage. Unlike mechanical fasteners, the cord distributes the load forces and separation forces throughout the panel system providing greater strength and reduced failure. After the load is removed or the panel system is unrolled, the panels return to their original flat shape.

Failure of the panel system can be easily repaired whether the failures occur in the binding cord or the panels. Individual panels and the cord are easily replaced or repaired.

Preferably, the individual panels are preferably made by one piece injection, molding method with rigid or semi rigid, polymeric plastic materials resulting in low cost construction and durable and lightweight function. The panel could also be constructed from stamped metal. The bottom lip is lower than the top edge of the panel and is designed to fit underneath the bottom edge of an adjacent panel, creating a flat and flush surface with the holes of the adjacent panels aligned for receipt of the binding cord. The overlapping panels provide additional strength to the overlapping panel assembly and limits mud, sand or other terrain from easily passing through the interlaced panel system.

The top of the panels can have a nonskid surface, and in the preferred embodiment, the panel's top has several circular protrusions, but the panel system provides for essentially a flat surface.

In a preferred embodiment (but not the only embodiment), the panel is 4 inches by 4 inches with the lip having a ⅝ inch width and 4 inches by 4 inches in length. The panel has a preferred thickness of approximately ¼ inch. The individual panels can also be made of various sizes and shapes from one inch by one inch to eight feet by twenty feet. The panel thickness can be less than ⅛ inch and up to twelve inches. Alternatively, the panels can be stacked on top of each other providing for multiple panel layers for increased thickness and strength.

Grooves or recesses can be included in the top of the panels between the holes to allow the cord to be laid flush on the top surface and/or the bottom surface of the panel. These grooves can also facilitate installation of the cord.

Although, the preferred embodiment exhibits the necessary strength and durability characteristics while remaining relatively lightweight and flexible, the interlaced panels can be utilized with different and various dimensions and configurations of the panel such as thickness, weight, size of lip, length of panel, shape of panels and methods of manufacture.

### BRIEF DESCRIPTION OF THE DRAWINGS

FIG. 1 is a perspective view of a panel.

FIG. 2 is a top view of a panel.

FIG. 3 is a side elevation view of a panel.

FIG. 4 is a bottom view of a panel.

FIG. 5 is a top view of overlapping panels interlaced with binding cord.

FIG. 6 is side elevation view of FIG. 5.

FIG. 7 is a perspective view of FIG. 5.

FIG. 8 is a top view of multiple panels interlaced with binding cord.

FIG. 9 is a perspective view of the panel system in use.

### DETAILED DESCRIPTION OF THE INVENTION

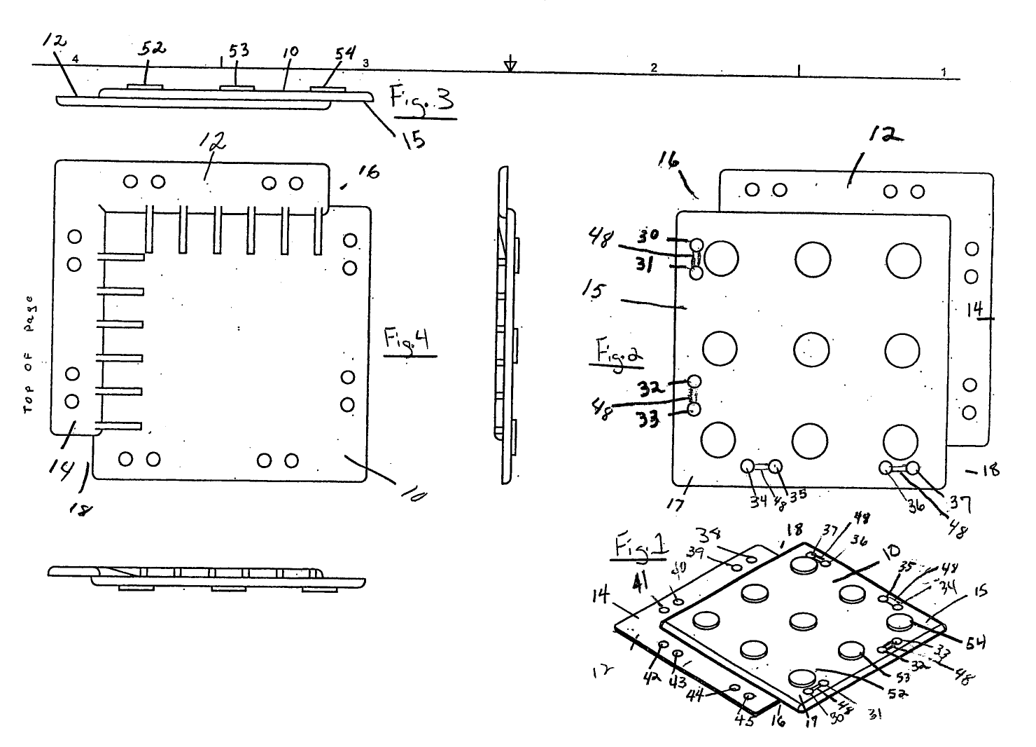

The present invention relates to an improved portable, lightweight load bearing structure having an interlaced collection of overlapping, semi-rigid panels fitted together to form a continuous generally flush and flat load-bearing surface. In FIG. 1-4, each panel 10 is made of a rigid or semi-rigid material preferably polymeric plastic material, rubber or any other moldable and/or castable material. In a preferred embodiment (but not the only embodiment), the panel is 4 inches by 4 inches with the lip having a ⅝ inch width and 4 inches by 4 inches in length. The panels, however, can be virtually any geometric flat shape, including square, rectangular or triangular. The preferred flexibility of the panel system could be maintained if these sizes are tripled in dimensions. Preferably, the panel 10 has a thickness of approximately 2/8 inch, and the panel is made from a well-known one-piece injection molding manufacturing process. Referring to FIGS. 1-4, two adjoining edges about the perimeter of each panel are recessed to form two lower lips 12, 14, and the two opposing adjoining edges of the panel form upper lips 15, 17. The lower lips 13, 14 are disposed below the horizontal plane of the panel 10. In the preferred embodiment, the lower lip 12, 14 has approximately 20% of projected area out of plane of panel 10.

Preferably, the panel 10 is generally square shaped with the lower lips 12, 14 having diagonally opposite corners removed 16, 18. Referring to FIG. 1, the panel 10 has uniformly spaced openings, 30-45 in the panel 10. In the preferred embodiment, the panel has two pairs of openings along the perimeter of each side of the panel. Grooves 48 or recesses can be included in the top of the panel 10 between the openings 30-31, 32-33, 34-35 and 36-37 to allow the cord 50 to be laid flush on the top surface of the panel.

The lips 12, 14, openings 30-45 and grooves 48 are integrated into the panel 10 and formed during the manufacturing injection molding process and do not rely on further assembly. The top of the panel 10 can have raised, contact surfaces 52, 53, 54 to provide for traction. In the one-piece injection, molding manufacturing process, the panel, its lip, the openings, grooves and contact surfaces are formed.

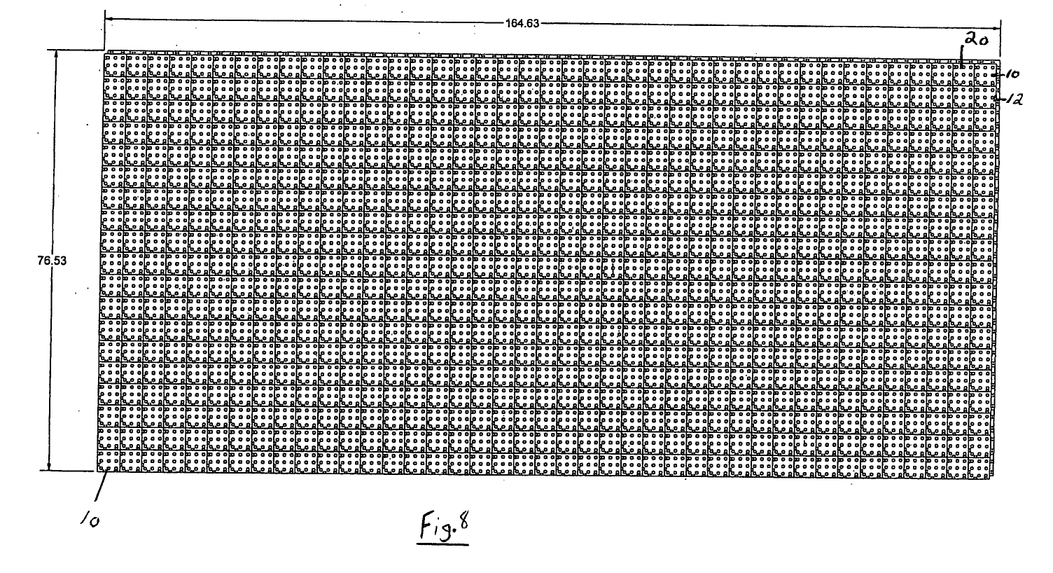

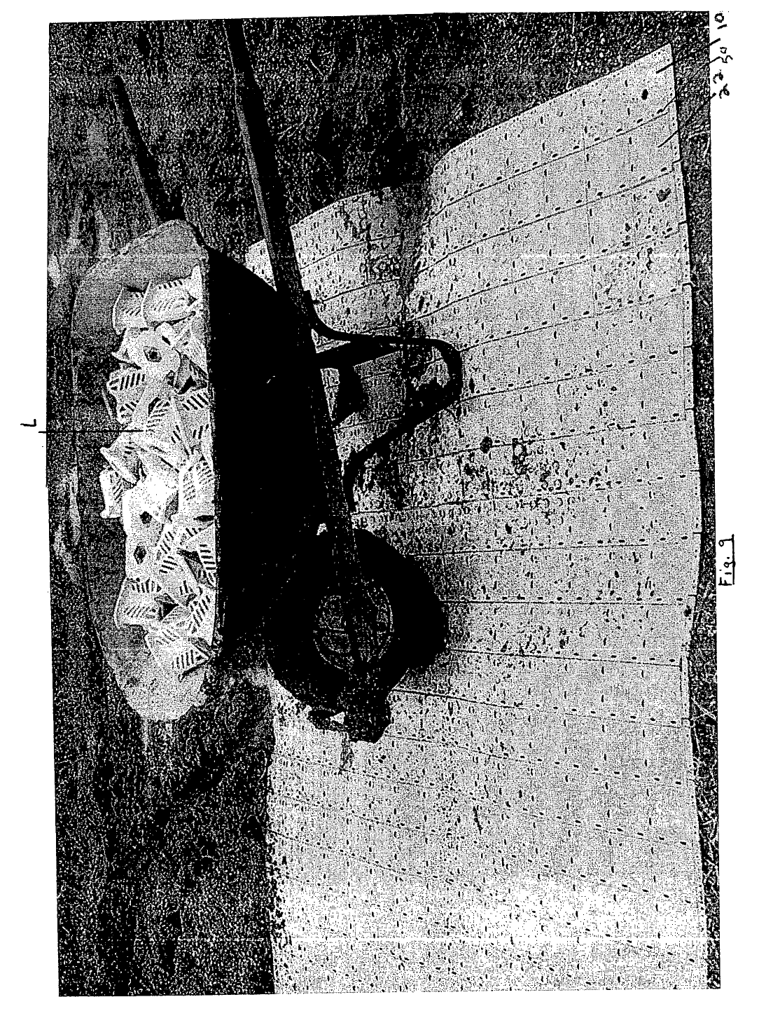

Referring to FIGS. 5-7, an interlacing means such as a cord 50, wire, strap or other rope type material is used to pass through overlapping aligned openings in adjacent panels 10, 20, 21, 22 to secure multiple panels together. The preferred binding cord 50 is durable, flexible and sized at approximately ⅛ inch diameter with a polyester braid. Any known interlacing, tying or stitching method can be utilized to attach the panels, and a single cord 50 or additional cords 52 can be used to attach multiple overlapping panels 10, 20, 21, 22 in a variety of shapes and dimensions. Preferably, the cord 50 is passed through the first aligned opening 37 from the bottom upward and then passed downward from the top of the panel 10 through the next aligned opening 36 under and across the bottom of the panels 10, 22 and laced upward through the next aligned opening 35 and then continuously interlaced along a linear series of aligned openings securely fastening the panels 10, 20, 21, 22 together.

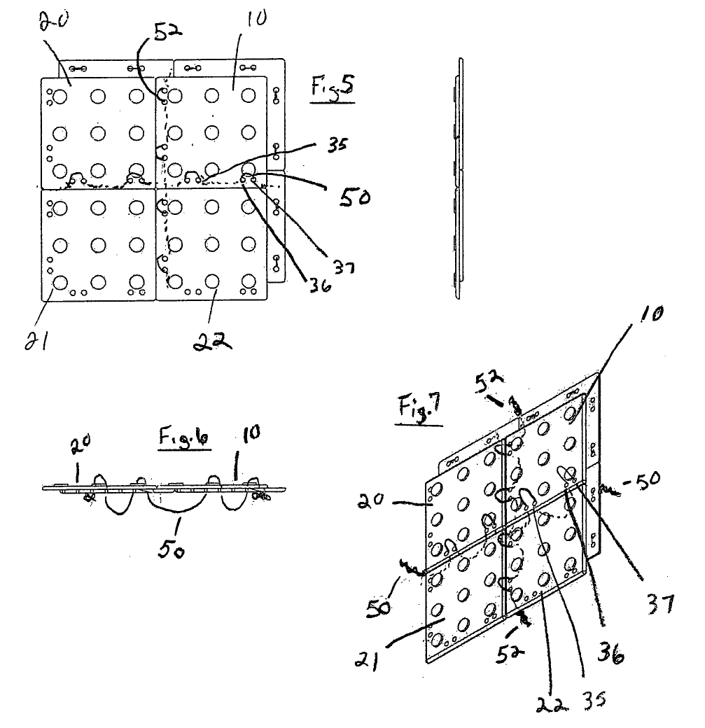

Assembly of the interlacing panel system occurs when the top panel 10 is placed and aligned on the lower lip of adjacent panel 20 as shown in FIGS. 3, 5 and 6. The binding cord, 50 and 52 pass in, over and through the pair of overlapping aligned holes of the upper lips of a panel and the lower lip of an adjacent panel. In this manner, the panels are interlaced or stitched together. The binding of the multiple panels with interlacing means provides for limited movement and flexibility between adjacent panels allowing for the interlaced panels to be rolled up for storage and transportation and unrolled where needed. As indicated in FIG. 9, the stitching and/interlacing of panels allows for limited deformity of the flat shape and dispersal of the load L along the cord and among multiple panels. After removal or reduction in the load, the panel system can return to its original flat shape The panels and panel systems can be made of various sizes, as shown in FIG. 8, and the preferred embodiment exhibits the necessary strength and durability characteristics while remaining relatively lightweight. The individual panels can also be made of various sizes and shapes from one inch by one inch to eight feet by twenty feet. The panel thickness can be less than ⅛ inch and up to twelve inches. Alternatively, the panels can be stacked on top of each other providing for multiple panel layers for increased thickness and strength.

Various changes can be made in the shape, size or arraignments of the panels and the use of equivalent elements of materials may be substituted for those illustrated and described. Its features and parts may be reversed.

What is claimed is:

1. An interlaced panel system for temporary ground support comprising:
a plurality of panels;
two adjoining edges about the perimeter of said panel being recessed from the top of said panels to form adjoining lower lips along one side and one end of said panels and the two opposing adjoining edges of the panel form upper lips;
wherein the depth to which said panel edges are recessed to form said lower lips about the entire perimeter of said panels being substantially the same, such that two diagonally opposite corners of said panels are removed in the areas where said upper lips would otherwise intersect with said lower lips, thus allowing for the overlapping of said upper lips and said lower lips about the edges of said panel with respective said lower lips and said upper lips of other like panels when placed adjacent thereto for joining therewith by which said overlapping panels have a generally flat and continuous top surface;
whereas said panels have at least one opening in each said adjoining lower lips and at least one opening in each said upper lips;
said openings are uniformly spaced to be aligned with said openings of overlapping adjacent panel;
wherein said openings are sized and aligned to allow an interlacing means to pass into and through said aligned overlapping openings for securing panels together.

2. The interlaced panel system of claim 1 wherein said panels are manufactured from one-piece molded construction.

3. The interlaced panel system of claim 1 wherein the interlacing means is a rope, cord or wire.

4. The interlaced panel system of claim 3 wherein said panels are uniformly sized and said panels are in square or rectangular geometry.

5. The interlaced panel system of claim 1 wherein said panels are uniformly sized and said panels are in square or rectangular geometry.

6. The interlaced panel system of claim 3 wherein the panels are semi rigid.

7. The interlaced panel system of claim 2 wherein the panels have a traction enhancing top surface.

8. The interlaced panel system of claim 4 wherein the panels have a traction enhancing top surface.

9. The interlaced panel system of claim 5 wherein the panels' upper lips and the lower lips have grooves disposed between and connecting said openings in a manner such that the interlacing means can be laid flush with said top surface of the panels.

10. The interlaced panel system of claim 2 wherein the panels' upper lips and the lower lips have grooves disposed between and connecting said openings in a manner such that the interlacing means can be laid flush with said top surface of the panels.

11. The interlaced panel system of claim 2 wherein the panels are semi rigid and wherein the panels' upper lips and the lower lips have grooves disposed between and connecting said openings in a manner such that the interlacing means can be laid flush with said top surface of the panels and wherein the panels have a traction enhancing top surface.
